(19) United States
(12) Patent Application Publication
(10) Pub. No.: US 2019/0127662 A1
(43) Pub. Date: May 2, 2019

(54) WATER BASED ADHESIVE REMOVAL COMPOSITION

(71) Applicant: KANG ZHUN ELECTRONICAL TECHNOLOGY (KUNSHAN) CO., LTD., Kunshan (CN)

(72) Inventors: XIAO-BO XIN, Kunshan (CN); JING-HUA CHEN, Kunshan (CN); WEI-XIAN XU, Kunshan (CN); MEI-CHUN CHENG, Kunshan (CN); NA CAI, Kunshan (CN)

(21) Appl. No.: 15/810,251

(22) Filed: Nov. 13, 2017

(30) Foreign Application Priority Data
Oct. 27, 2017 (CN) 201711026850.9

(51) Int. Cl. C11D 3/04; C11D 3/08; C11D 3/10; C11D 3/20; C11D 3/30; C11D 1/66; C11D 1/12; C09D 9/00

(52) U.S. Cl. CPC C11D 3/044; C11D 3/08; C11D 3/10; C11D 3/2003; C11D 3/128; C11D 1/667; C11D 1/12; C09D 9/005; C11D 3/30

(57) ABSTRACT

A water based adhesive removal composition which is effective and non-residual on magnesium and alloys comprises an alkali, a main solvent, a volatilization inhibitor, a cosolvent, a corrosion inhibitor, a penetrant, a thickening agent, a surface active agent, and water. The water based adhesive removal composition is water-based formula, the water-based formula is not easy to volatilize and is not flammable. When being used to remove adhesive attached on the magnesium alloy component, there is no risk of magnesium ignition.

### FIELD

The subject matter herein generally relates to a water based adhesive removal composition.

### BACKGROUND

The housing of an electronic device can be a magnesium alloy component being adhered to another component, such as a fiberglass plastic component. In the process of manufacture the housing, sometimes the housing is defective, and needs to be repaired, thus the adhesive adhered on the magnesium alloy component needs to be removed from the magnesium alloy component. However the ignition point of the magnesium is very low, a general adhesive removal composition cannot be used to remove the adhesive attached on the magnesium alloy component. An adhesive removal composition to remove the adhesive attached on the magnesium alloy component is needed.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like. The term “about” when utilized, means “not only includes the numerical value, but also includes numbers closest to the numerical value”.

In an exemplary embodiment, a water based adhesive removal composition comprises an alkali, a main solvent, a volatilization inhibitor, a cosolvent, a corrosion inhibitor, a penetrant, a thickening agent, a surface active agent, and water.

In at least one exemplary embodiment, the alkali has a mass percentage of about 20% to about 30% of the total mass of the water based adhesive removal composition. The main solvent has a mass percentage of about 10% to about 30% of the total mass of the water based adhesive removal composition. The volatilization inhibitor has a mass percentage of about 1% to about 3% of the total mass of the water based adhesive removal composition. The cosolvent has a mass percentage of about 5% to about 10% of the total mass of the water based adhesive removal composition. The corrosion inhibitor has a mass percentage of about 0.5% to about 1.5% of the total mass of the water based adhesive removal composition. The penetrant has a mass percentage of about 0.5% to about 1.5% of the total mass of the water based adhesive removal composition. The thickening agent has a mass percentage of about 1.5% to about 5% of the total mass of the water based adhesive removal composition. The surface active agent has a mass percentage of about 0.5% to about 5% of the total mass of the water based adhesive removal composition. The water has a mass percentage of balance of the total mass of the water based adhesive removal composition.

The water based adhesive removal composition is used to remove an adhesive attached on a magnesium alloy component. Normally, a main component of the adhesive is acrylic resin and epoxy resin. The alkali can cause the non-solid gum molecule bond and solidified gum molecule bond to swell and fracture, thus speeding up the dissolving and stripping adhesive from the magnesium alloy component. In the water based adhesive removal composition, when the alkali has a mass percentage more than 30%, the solvent will cause salt-out stratification. In the water based adhesive removal composition, when the alkali has a mass percentage less than 20%, a speed of the swelling and fracture of the gum molecule bond will be slow, and the swelling of the gum molecule bond will be to a lesser extent.

The alkali may be an inorganic alkali or an organic alkali. The inorganic alkali may be selected from sodium hydroxide, potassium hydroxide, sodium carbonate, sodium metasilicate, or any combination thereof. The organic alkali may be selected from monoethanolamine, diethanol amine, ethanediamine, or any combination thereof.

The inorganic alkali cooperates with the surface active agent to impart powerful swelling and emulsifying properties to the water based adhesive removal composition. The organic alkali has a strong swelling capacity and a low corrosiveness to organic molecule. The organic alkali cooperates with the surface active agent to accelerate osmotic swelling by the water based adhesive removal composition, thus the organic molecule fractures quickly.

The main solvent may be selected from 2-Ethoxyethanol, butyldiglycol, Ethylene glycol monobutyl ether, 1-[2-(2-methoxy-1-methylethoxy)-1-methylethoxy]-2-Propanol, 1-(1-Butoxy-2-propoxy)-2-propanol, DipropyleneGlycol n-Propyl Ether, methyl isoamyl ketone, 1-Methyl-2-pyrrolidinone (NMP), 2-Ethoxyethyl acetate, or any combination thereof.

The 2-Ethoxyethanol, butyldiglycol, the Ethylene glycol monobutyl ether, the 1-[2-(2-methoxy-1-methylethoxy)-1-methylethoxy]-2-Propanol, and the 1-(1-Butoxy-2-propoxy)-2-propanol are alcohol ether solvent with high boiling point.

The volatilization inhibitor may be selected from ceresin wax, peregal, or any combination thereof.

The cosolvent may be selected from amyl alcohol, hexyl alcohol, anone, enanthol, n-caprylic alcohol, benzil alcohol, glycol, propanediol, polyethylene glycol, or any combination thereof.

The corrosion inhibitor may be selected from 1H-Benzotriazole, sodium metasilicate, hexamethylenetetramine, silane ketone, carboxylic alcohol amine, sodium benzoate, or any combination thereof.

The penetrant may be selected from penetrant JFC, quick penetrant T, alkali-resisting penetrant OEP-70, alkali-resisting penetrant AEP, or any combination thereof.

The thickening agent may be selected from cellulose thickening agent, polyvinyl alcohol thickening agent, magnesium aluminum silicate thickening agent, or any combination thereof. The cellulose thickening agent may be selected from methylcellulose, ethyl cellulose, carboxymethylcellulose, carboxymethyl cellulose, hydroxypropyl cellulose, hydroxypropyl methyl cellulose, or any combination thereof. The polyvinyl alcohol thickening agent may be selected from polyvinyl alcohol 400, polyvinyl alcohol 600, polyvinyl alcohol 800, polyvinyl alcohol 100, or any combination thereof. The magnesium aluminum silicates thickening agent is not flammable.

The surface active agent is a mixture of an anionic surface active agent and a nonionic surface active agent. The anionic surface active agent may be selected from α-olefin sulfosalt (AOS), sodium dodecyl-benzenesulfonate (LAS), sodium alcohol ether sulphate (AES), sodium dimethyl sulfonate, docusate sodium, and quick penetrant T, or any combination thereof. The nonionic surface active agent may be selected from alpha-isooctadecyl-omega-hydroxy-poly(oxy-2-ethanediyl), alkylphenol ethoxylates (OP-10), span-60, span-80, tween, fatty acid methyl ester ethoxylate (FMEE), or any combination thereof.

The surface active agent has a hydrophilic lipophilic balance (HLB) greater than 10.

The water based adhesive removal composition is water-based formula, the water-based formula is not easy to volatilize and is not flammable. The water based adhesive removal composition can be heated for use, and has a good biodegradability. The water based adhesive removal composition dose not comprise harmful ingredients. The surface of the magnesium alloy component after adhesive removaldoes not have oil or fat residue, thus the magnesium alloy component can be washed by water.

### EXAMPLE 1

The water based adhesive removal composition comprises sodium hydroxide, benzil alcohol, NMP, butyldiglycol, LAS, OP-10, 1H-Benzotriazole, methylcellulose, alkali-resisting penetrant OEP-70, ceresin wax, and water.

The sodium hydroxide has a mass concentration of 250 g/L, the benzil alcohol has a mass concentration of 50 g/L, the NMP has a mass concentration of 100 g/L, the butyldiglycol has a mass concentration of 100 g/L, the LAS has a mass concentration of 25 g/L, the OP-10 has a mass concentration of 25 g/L, the 1H-Benzotriazole has a mass concentration of 10 g/L, the methylcellulose has a mass concentration of 20 g/L, the alkali-resisting penetrant OEP-70 has a mass concentration of 10 g/L, and the ceresin wax has a mass concentration of 20 g/L.

When using the water based adhesive removal composition to remove an AB glue attached on a surface of a magnesium alloy component, heat the water based adhesive removal composition to 80 degrees Celsius, then immerse the magnesium alloy component in the water based adhesive removal composition for about 1 hour to about 2 hours, to have the AB glue softened, then remove the softened AB glue.

### EXAMPLE 2

The water based adhesive removal composition comprises sodium hydroxide, n-caprylic alcohol, methyl isoamyl ketone, 2-Ethoxyethanol, AOS, span-80, 1H-Benzotriazole, methylcellulose, alkali-resisting penetrant OEP-70, ceresin wax, and water.

The sodium hydroxide has a mass concentration of 250 g/L, the n-caprylic alcohol has a mass concentration of 50 g/L, the methyl isoamyl ketone has a mass concentration of 100 g/L, the 2-Ethoxyethanol has a mass concentration of 100 g/L, the AOS has a mass concentration of 25 g/L, the span-80 has a mass concentration of 25 g/L, the 1H-Benzotriazole has a mass concentration of 10 g/L, the methylcellulose has a mass concentration of 20 g/L, the alkali-resisting penetrant OEP-70 has a mass concentration of 10 g/L, and the ceresin wax has a mass concentration of 20 g/L.

The water based adhesive removal composition comprises sodium hydroxide and span-80. The sodium hydroxide is an alkali, the span-80 is a nonionic surface active agent. The sodium hydroxide cooperates with the span-80 to give the water based adhesive removal composition powerful swelling and emulsifying capacities.

When using the water based adhesive removal composition to remove an AB glue attached on a surface of a magnesium alloy component, heat the water based adhesive removal composition to 80 degrees Celsius, then immerse the magnesium alloy component in the water based adhesive removal composition for about 0.5 hour to about 1 hour, to have the AB glue softened and removed by peeling.

### EXAMPLE 3

The water based adhesive removal composition comprises monoethanolamine, n-caprylic alcohol, NMP, 1-[2-(2-methoxy-1-methylethoxy)-1-methylethoxy]-2-Propanol, AES, OP-10, 1H-Benzotriazole, magnesium aluminum silicates thickening agent, alkali-resisting penetrant AEP, ceresin wax, and water.

The monoethanolamine has a mass concentration of 300 g/L, the n-caprylic alcohol has a mass concentration of 50 g/L, the NMP has a mass concentration of 100 g/L, the 1-[2-(2-methoxy-1-methylethoxy)-1-methylethoxy]-2-Propanol has a mass concentration of 100 g/L, the AES has a mass concentration of 25 g/L, the OP-10 has a mass concentration of 25 g/L, the 1H-Benzotriazole has a mass concentration of 10 g/L, the magnesium aluminum silicates thickening agent has a mass concentration of 5 g/L, the alkali-resisting penetrant AEP has a mass concentration of 10 g/L, and the ceresin wax has a mass concentration of 20 g/L.

The water based adhesive removal composition comprises monoethanolamine. The monoethanolamine is an organic alkali. The monoethanolamine has strong swelling powers and low corrosiveness to organic molecule.

When using the water based adhesive removal composition to remove an AB glue attached on a surface of a magnesium alloy component, heat the water based adhesive removal composition to 80 degrees Celsius, then immerse the magnesium alloy component into the water based adhesive removal composition for about 0.5 hour to about 1 hour, to have the AB glue softened and peelable.

### EXAMPLE 4

The water based adhesive removal composition comprises monoethanolamine, benzil alcohol, methyl isoamyl ketone, butyldiglycol, quick penetrant T, FMEE, 1H-Benzotriazole, magnesium aluminum silicates thickening agent, alkali-resisting penetrant AEP, ceresin wax, and water.

The monoethanolamine has a mass concentration of 300 g/L, the benzil alcohol has a mass concentration of 50 g/L, the methyl isoamyl ketone has a mass concentration of 100 g/L, the butyldiglycol has a mass concentration of 100 g/L, the quick penetrant T has a mass concentration of 25 g/L, the FMEE has a mass concentration of 25 g/L, the 1H-Benzotriazole has a mass concentration of 10 g/L, the magnesium aluminum silicates thickening agent has a mass concentration of 5 g/L, the alkali-resisting penetrant AEP has a mass concentration of 10 g/L, and the ceresin wax has a mass concentration of 20 g/L.

The water based adhesive removal composition comprises monoethanolamine and quick penetrant T. The monoethanolamine is an organic alkali, the quick penetrant T is an anionic surface active agent and a penetrant. The monoethanolamine cooperates with the quick penetrant T to give the water based adhesive removal composition a powerful osmotic swelling capability, to have the organic molecule fracture quickly.

When using the water based adhesive removal composition to remove an AB glue attached on a surface of a magnesium alloy component, heat the water based adhesive removal composition to 80 degrees Celsius, then immerse the magnesium alloy component into the water based adhesive removal composition for about 0.5 hour to about 1 hour, to have the AB glue softened and peelable.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A water based adhesive removal composition comprising:
an alkali;
a main solvent;
a volatilization inhibitor;
a cosolvent;
a corrosion inhibitor;
a penetrant;
a thickening agent;
a surface active agent; and
water.

2. The water based adhesive removal composition of claim 1, wherein the alkali has a mass percentage of about 20% to about 30% of the total mass of the water based adhesive removal composition, the main solvent has a mass percentage of about 10% to about 30% of the total mass of the water based adhesive removal composition, the volatilization inhibitor has a mass percentage of about 1% to about 3% of the total mass of the water based adhesive removal composition, the cosolvent has a mass percentage of about 5% to about 10% of the total mass of the water based adhesive removal composition, the corrosion inhibitor has a mass percentage of about 0.5% to about 1.5% of the total mass of the water based adhesive removal composition, the penetrant has a mass percentage of about 0.5% to about 1.5% of the total mass of the water based adhesive removal composition, the thickening agent has a mass percentage of about 1.5% to about 5% of the total mass of the water based adhesive removal composition, the surface active agent has a mass percentage of about 0.5% to about 5% of the total mass of the water based adhesive removal composition.

3. The water based adhesive removal composition of claim 1, wherein the alkali is inorganic alkali or organic alkali.

4. The water based adhesive removal composition of claim 3, wherein the inorganic alkali is selected from sodium hydroxide, potassium hydroxide, sodium carbonate, sodium metasilicate, and any combination thereof.

5. The water based adhesive removal composition of claim 3, wherein the organic alkali is selected from monoethanolamine, diethanol amine, ethanediamine, and any combination thereof.

6. The water based adhesive removal composition of claim 1, wherein the main solvent is selected from 2-Ethoxyethanol, butyldiglycol, Ethylene glycol monobutyl ether, 1-[2-(2-methoxy-1-methylethoxy)-1-methylethoxy]-2-Propanol, 1-(1-Butoxy-2-propoxy)-2-propanol, DipropyleneGlycol n-Propyl Ether, methyl isoamyl ketone, 1-Methyl-2-pyrrolidinone, 2-Ethoxyethyl acetate, and any combination thereof.

7. The water based adhesive removal composition of claim 1, wherein the volatilization inhibitor is selected from ceresin wax, peregal, and any combination thereof.

8. The water based adhesive removal composition of claim 1, wherein the cosolvent is selected from amyl alcohol, hexyl alcohol, anone, enanthol, n-caprylic alcohol, benzil alcohol, glycol, propanediol, polyethylene glycol, and any combination thereof.

9. The water based adhesive removal composition of claim 1, wherein the corrosion inhibitor is selected from 1H-Benzotriazole, sodium metasilicate, hexamethylenetetramine, silane ketone, carboxylic alcohol amine, sodium benzoate, and any combination thereof.

10. The water based adhesive removal composition of claim 1, wherein the penetrant is selected from penetrant JFC, quick penetrant T, alkali-resisting penetrant OEP-70, alkali-resisting penetrant AEP, and any combination thereof.

11. The water based adhesive removal composition of claim 1, wherein the thickening agent is selected from celluloses thickening agent, polyvinyl alcohol thickening agent, magnesium aluminum silicates thickening agent, and any combination thereof.

12. The water based adhesive removal composition of claim 11, wherein the celluloses thickening agent is selected from methylcellulose, ethyl cellulose, carboxymethylcellulose, carboxymethyl cellulose, hydroxypropyl cellulose, hydroxypropyl methyl cellulose, and any combination thereof.

13. The water based adhesive removal composition of claim 11, wherein the polyvinyl alcohol thickening agent is selected from polyvinyl alcohol 400, polyvinyl alcohol 600, polyvinyl alcohol 800, polyvinyl alcohol 100, and any combination thereof.

14. The water based adhesive removal composition of claim 1, wherein the surface active agent is a mixture of an anionic surface active agent and a nonionic surface active agent.

15. The water based adhesive removal composition of claim 14, wherein the anionic surface active agent is selected from α-olefin sulfosalt, sodium dodecyl-benzenesulfonate, sodium alcohol ether sulphate, sodium dimethyl sulfonate, docusate sodium, and quick penetrant T, and any combination thereof.

16. The water based adhesive removal composition of claim 14, wherein the nonionic surface active agent is selected from alpha-isooctadecyl-omega-hydroxy-poly(oxy-2-ethanediyl), alkylphenol ethoxylates, span-60, span-80, tween, fatty acid methyl ester ethoxylate, and any combination thereof.
